(19) United States
(12) Patent Application Publication
(10) Pub. No.: US 2010/0091496 A1
(43) Pub. Date: Apr. 15, 2010

(54) LIGHT EMITTING DIODE (LED) LIGHTING TUBE THAT CAN BE DISASSEMBLED AND REPAIRED

(76) Inventor: Jose Antonio AMORAGA RODRIGUEZ, Barcelona (ES)

Correspondence Address: EGBERT LAW OFFICES, 412 MAIN STREET, 7TH FLOOR, HOUSTON, TX, 77002, US

(21) Appl. No.: 12/429,895

(22) Filed: Apr. 24, 2009

(30) Foreign Application Priority Data
Oct. 14, 2008 (ES) U200802122

(51) Int. Cl. F21S 4/00

(52) U.S. Cl. 362/249.04

(57) ABSTRACT

The invention relates to a lighting tube with light emitting diodes (LEDs) that can be disassembled and repaired. The present invention presents substantial advantages and innovative characteristics as well as other advantages related to organization and construction. The invention is centered on a lighting tube which, while preferably adopting the standardized dimensions of commonly used fluorescent tubes, as well as a similar system for lateral attachment and connection, is different. It is provided inside the transparent tubular body that forms it with a lighting system based on light emitting diodes or LEDs, giving the tube the advantages of this lighting system, essentially based on a greater illumination intensity with a considerably lower consumption, the possibility of repairing the tube and a much longer useful lifetime.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The field of application of the present in invention lies in the industry sector related to manufacturing lighting apparatuses and devices.

2. Description of Related Art Including Information Disclosed Under 37 CFR 1.97 and 37 CFR 1.98.

Currently, as a reference to the state of the art, although multiple devices and systems are known that use light emitting diodes (LEDs). It must be noted that the applicant is not aware of the existence of any invention having technical, structural or configuration characteristics similar to those of that disclosed herein.

### BRIEF SUMMARY OF THE INVENTION

Thus, the lighting tube based on LEDs (Light Emitting Diodes) that can be disassembled and repaired proposed by the invention is configured with noteworthy novelty within its field of application, as it clearly provides an innovative lighting system with a lower consumption and greater duration, as well as additional advantages, these characterizing details being suitably specified in the final claims appended to this description.

Specifically, the invention consists of a lighting tube externally similar in shape and size to a conventional fluorescent tube, being different in that inside the transparent tubular body it has a lighting system formed by a plurality of LEDs (Light Emitting Diodes) coupled to an internal piece.

Thus, this piece is made of any suitable flexible material and has an elongated rectangular shape and a length identical to that of the transparent tube, which may be made of glass or acrylic glass as desired, and a width preferably somewhat greater than the diameter of said tube, incorporating the LEDs equidistantly distributed along the length and width of its surface. Naturally, the number of LEDs will depend on the size of the tube, the bigger the tube, the more LEDs it will contain and therefore the greater its illumination capacity.

This aforementioned piece is inserted in the tube through one of the ends of the tube and is slightly curved in its middle area as it is wider than the tube, which results in an advantageous opening of the angle of incidence of the light, increasing the illuminated area as the inclination will be convex on its outside part, on which the LEDs are placed, and concave on the opposite side, which is used to incorporate the electronic circuit needed for its operation.

It should be noted that to guide the concave positioning of the piece, the tube is internally provided with a support element with a configuration having angled ends that engages the sides of the piece to ensure that it adopts said curvature. This element is also used to embellish the rear part of the transparent tube, concealing the electronic circuit and the connections of the LEDs.

It is important to point out that on the ends of the transparent tubular body are established corresponding anchoring connectors which, in addition to acting as a cover for closing the ends, are attached to the side tabs of the support case of the assembly and joined to them, as in conventional fluorescent tubes, by the insertion of corresponding lugs in the grooves made in said tabs.

Note that at least one of the anchoring connectors has a threading, with a gasket to provide full tightness of the tube, meant to simplify the extraction of the piece that holds the LEDs from inside the tube and proceed to their replacement and/or repair, as faulty LEDs can be replaced with new ones without having to replace the entire tube. In addition, this anchoring connector is provided with the corresponding connection element for power supply to the electronic circuit. The connector on the opposite end will provide a complementary anchoring.

In view of the above, the advantages provided by the tube of the invention compared to conventional fluorescent tubes are clear. Thus, a LED-based lighting system will use much less power for a given light intensity, and a tube of the same size will provide a greater luminosity and a greater field of illumination. On another hand, the useful lifetime of the lamp is considerably extended, as in addition to the fact that LEDs last longer than fluorescent tubes, the piece holding them can be easily extracted from the tube to allow repairing it or replacing it entirely.

The illumination tube described therefore represents an innovative structure with structural and constitutional characteristics hitherto unknown for this purpose, which joined to its practicality provides sufficient grounds for obtaining the requested privilege of exclusivity

### BRIEF DESCRIPTION OF THE SEVERAL VIEWS OF THE DRAWINGS

To complete the description being made and to aid a better understanding of the characteristics of the invention, the present descriptive memory is accompanied by a set of drawings which form an integral part of the description where, for purposes of illustration only and in a non-limiting sense.

FIG. 1 shows a perspective view of an example of embodiment of the LED lighting tube that can be disassembled and repaired object of the invention, representing its main component parts and elements, as well as their configuration and disposition.

FIG. 2 shows an enlarged elevation view of a portion of the example of a tube according to the invention shown in the previous figure, that gives a clearer view of the disposition of the LEDs in the holding piece inside the tube and how this piece is anchored to the support.

FIG. 3 shows a sectional view along a transverse cut of the tube according to the invention, in this case representing the curvature adopted by the holding piece on which the LEDs are placed and the support that allows this positioning.

### DETAILED DESCRIPTION OF THE INVENTION

In view of the figures described above and according to the numbering used, an example of a preferred embodiment is seen comprising the parts specified and described in detail below.

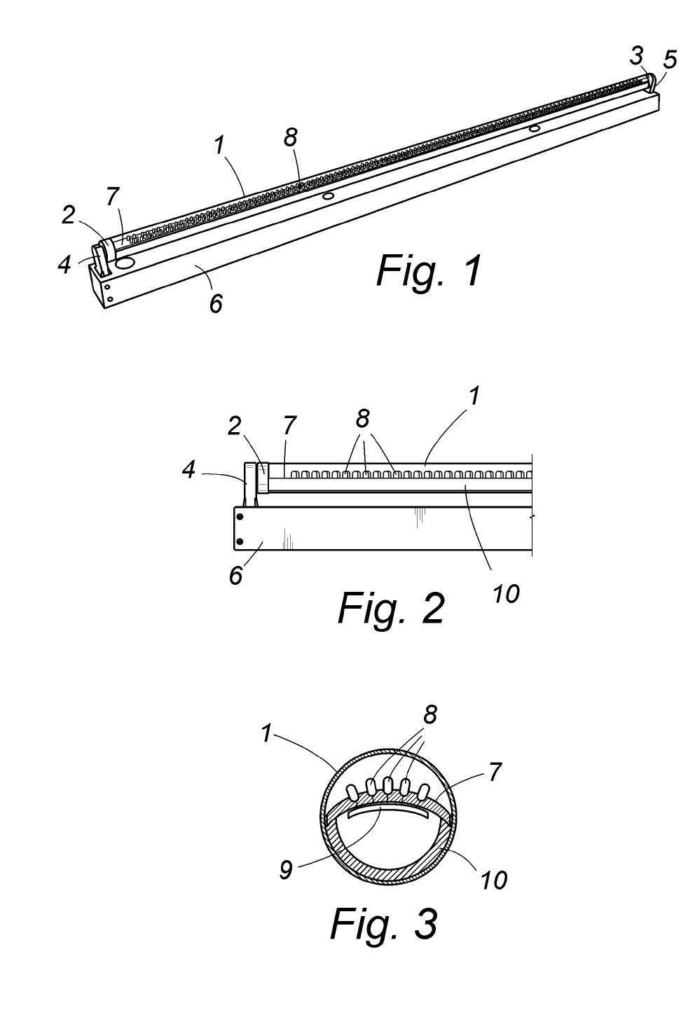

As shown in FIG. 1, the invention essentially consists in a lighting tube constituted by a tubular body (1) of transparent material, such as glass or acrylic glass, on the ends of which are corresponding anchoring connectors (2) and (3) provided with means for attachment to corresponding lateral tabs (4) and (5) of a support casing (6).

Said tubular body (1) is internally provided with a piece (7) made of any flexible material suitable for its intended use which incorporates, distributed equidistantly on its surface, a plurality of LEDs (8).

This piece (7) has an elongated rectangular shape, with a length nearly identical to the length of the tubular body (1) and a width similar to or, optionally, slightly greater than the diameter of said tubular body (1).

Said piece (7) is inserted in the tubular body through one of its ends and, if it is wider than the latter as shown in FIG. 3, will define a curve that is convex on its outer side, in which the aforementioned LEDs (8) are coupled, providing an advantageous opening of the angle of incidence of the light. The opposite part of the piece (7) incorporates the electronic circuit (9) needed for its operation.

To set the concave positioning of the piece (7), it is considered to incorporate inside the tubular body (1) an internal support element (10) with a configuration having angled ends that sets acting as a guide, the sides of the piece (7) so that they assume said curvature. This internal support (10) is preferably opaque, as it is also used to embellish the rear part of the tubular body (1), concealing the electronic circuit (9) and the connections of the LEDs (8).

On another hand, at least one of the anchoring connectors (2) and (3) that close the ends of the tubular body (1) and are attached to the lateral tabs (4) and (5) of the support casing (6) is provided with a thread and a gasket to provide a full tightness of the tube and simplify the extraction and handling of the piece (7) inside the tubular body (1), this anchoring connector also having the connection element for power supply to the electronic circuit (9).

Having sufficiently described the nature of the present invention, as well as its practical execution, it is not considered necessary to extend this explanation further for any expert in the field to understand its scope and the advantages derived thereof. Without departing from its essence, it can be executed in other embodiments different from the one given by way of example whether in the shape, materials or dimensions, which will be also covered by the protection sought provided its main principle is not altered, changed or modified.

1. A light emitting diode (LED) lighting tube comprising:
a tubular body being comprised of a transparent material and having ends of with corresponding anchoring connectors and means for attachment to lateral tabs of a support casing;
a piece of any flexible material housed inside said tubular body; and
a plurality of LEDs equidistantly distributed on an outer surface of the piece of flexible material, the piece of flexible material having an opposite face with an electronic circuit required for operation;
wherein the anchoring connectors closing ends of the tubular body and are attached to the lateral tabs of the support casing, at least one connector having a thread and a gasket to provide complete tightness of the tube and simplify the extraction and handling of the piece of flexible material for repair or replacement; and
wherein said at least one anchoring connector having a corresponding connection element for power supply to the electronic circuit.

2. The LED lighting tube, according to claim 1, wherein the pieces has an elongated rectangular shape, with a length practically identical to a shape of the tubular body and a width similar to a diameter of said tubular body.

3. The LED lighting tube that, according to claim 1, optionally, wherein the piece has an elongated rectangular shape, with a length practically identical a length of the tubular body, defining when introduced in said tubular body, a convex curve on an outside part thereof, the LEDs are being coupled on said outside part.

4. The LED lighting tube, according to claim 1, further comprising:
an internal support, setting a concave positioning of the piece, the internal support having a configuration with angled ends, in a guiding relationship to the sides of the piece.

5. The LED lighting tube, according to claim 4, wherein said internal support is opaque.
